(19) United States
(12) Patent Application Publication
(10) Pub. No.: US 2018/0003369 A1
(43) Pub. Date: Jan. 4, 2018

(54) FIXING STRUCTURE FOR ELECTRICAL DEVICE, ILLUMINATION DEVICE PROVIDED WITH SAID FIXING STRUCTURE, AND METHOD FOR FIXING AND REMOVING ELECTRICAL DEVICE

(71) Applicant: MINEBEA MITSUMI Inc., Nagano (JP)

(72) Inventors: Shinichi FUJISAWA, Akiruno (JP); Hiroya HOSHI, Iwata (JP)

(21) Appl. No.: 15/707,284

(22) Filed: Sep. 18, 2017

Related U.S. Application Data
(63) Continuation of application No. PCT/JP2016/060759, filed on Mar. 31, 2016.

(30) Foreign Application Priority Data
Mar. 31, 2015 (JP) 2015-071128

(51) Int. Cl. F21V 21/34; F21V 21/26; H01R 25/14; F21V 21/35; F21V 23/06; F21S 2/00

(52) U.S. Cl. CPC F21V 21/34; H01R 25/14; F21V 21/35; F21V 21/26; F21S 2/005; F21V 23/06

(57) ABSTRACT

A fixing structure for an electrical device of the present invention includes: a first operating unit that has a power receiving unit, which receives power feeding from a power feeding unit of a wiring duct, and that engages and disengages the power receiving unit with and from the power feeding unit; a second operating unit that has a second engagement portion, which is supported by a support unit of the wiring duct, and that engages and disengages the second engagement portion with and from the support unit; and a first lock portion that is provided in the first operating unit and locks the second operating unit.

### CROSS-REFERENCE TO RELATED APPLICATION

This application is a continuation of PCT international application Ser. No. PCT/JP2016/060759 filed on Mar. 31, 2016 which designates the United States, and which claims the benefit of priority from Japanese Patent Application No. 2015-071128, filed on Mar. 31, 2015; the entire contents of which are incorporated herein by reference.

### BACKGROUND OF THE INVENTION

### 1. Field of the Invention

The present invention relates to a fixing structure for an electrical device, an illumination device including the fixing structure, and a fixing and removing method for the electrical device.

### 2. Description of the Related Art

Illumination devices, in which the illumination devices are attached to wiring ducts arranged on ceilings and the like, have been conventionally known (see Patent Literature 1: Japanese Unexamined Patent Application Publication No. 2010-147002).

Such an illumination device is attached to a support rail and a power feeding rail, which are provided in a wiring duct so as to be separated vertically from each other and to run alongside each other, by engagement of an engagement projection of the illumination device with the support rail of the wiring duct and engagement of a power receiving unit of the illumination device with the power feeding rail of the wiring duct.

The illumination device disclosed in Patent Literature 1 has a fixing structure, in which an engagement portion (engagement projection) and the power receiving unit are provided coaxially.

In the above described illumination device, since the power receiving unit is a portion realizing an electrical contact, when the engagement portion is arranged coaxially with and closely to the power receiving unit, for safety aspects, insulating resin or the like is preferably used for the engagement portion.

However, when the engagement portion is formed of insulating resin or the like, if weight of the illumination device is large, support strength thereof may be deficient.

Accordingly, if the engagement portion is separately provided at another position along the wiring duct, a high strength material, such as metal, is able to be used for this engagement portion, and thus the above described support strength deficiency problem is able to be solved.

However, when the illumination device is removed, if the engagement portion is disengaged before the power receiving unit is disengaged, a large load is applied to the power receiving unit and may damage the power receiving unit.

On the contrary, when the illumination device is fixed, if a sequence, in which the engagement of the power receiving unit is carried out first and the engagement of the engagement portion is carried out next, is adopted, a large load is applied to the power receiving unit until the engagement of the engagement portion is completed and may damage the power receiving unit.

Not being limited only to electrical devices like illumination devices, the same applies to, for example, electrical devices like cameras, which are attached to wiring ducts.

The present invention has been made in view of the above described circumstances, and aims to provide an electrical device, such as an illumination device, for which damage thereof due to an overload on a power receiving unit thereof upon fixing and removal of the electrical device to and from a wiring duct is prevented.

### SUMMARY OF THE INVENTION

The present invention is, to achieve the above object, grasped by the following configurations.

A fixing structure according to one aspect of the invention is a fixing structure for fixing an electrical device to a wiring duct, and includes a first operating unit that has a power receiving unit, which receives power feeding from a power feeding unit of the wiring duct, and that engages and disengages the power receiving unit with and from the power feeding unit; a second operating unit that has a second engagement portion supported by a support unit of the wiring duct, and that engages and disengages the second engagement portion with and from the support unit; and a first lock portion that is provided in the first operating unit and that locks the second operating unit.

### BRIEF DESCRIPTION OF THE DRAWINGS

FIG. 1 is a diagram illustrating a state, in which an illumination device of an embodiment has been fixed to a wiring duct.

FIG. 2 is a sectional view along a line P-P in FIG. 1.

FIG. 3 is a perspective view illustrating a power supply unit of the embodiment.

FIG. 4 is an exploded perspective view of a first operating unit and a second operating unit of the embodiment.

FIG. 5 is a partial sectional view illustrating a state, in which the first operating unit and the second operating unit have been attached to a wall surface portion of the power supply unit of the embodiment.

FIG. 6 is a front view, in which the wall surface portion of the power supply unit of the embodiment is viewed at the front, and is a diagram illustrating the first operating unit and the second operating unit both in disengaged states thereof.

FIG. 7 is a front view, in which the wall surface portion of the power supply unit of the embodiment is viewed at the front, and is a diagram illustrating the first operating unit in the disengaged state and the second operating unit in an engaged state.

FIG. 8 is a front view, in which the wall surface portion of the power supply unit of the embodiment is viewed at the front, and is a diagram illustrating the first operating unit and the second operating unit both in engaged states thereof.

### DETAILED DESCRIPTION OF THE PREFERRED EMBODIMENTS

A fixing structure according to one aspect of the invention is a fixing structure for fixing an electrical device to a wiring duct, and includes a first operating unit that has a power receiving unit, which receives power feeding from a power feeding unit of the wiring duct, and that engages and disengages the power receiving unit with and from the power feeding unit; a second operating unit that has a second engagement portion supported by a support unit of the wiring duct, and that engages and disengages the second engagement portion with and from the support unit; and a first lock portion that is provided in the first operating unit and that locks the second operating unit.

In the fixing structure according to one aspect of the invention, by the second operating unit being locked by the first lock portion, an operation of the second operating unit is prevented, the operation being for disengagement of the second engagement portion from the support unit, until the power receiving unit is disengaged from the power feeding unit.

In the fixing structure according to one aspect of the invention, the second operating unit includes a second lock portion that locks the first operating unit, and by the first operating unit being locked by the second lock portion, an operation of the first operating unit is prevented, the operation being for engagement of the power receiving unit with the power feeding unit, until the second engagement portion is engaged with the support unit.

In the fixing structure according to one aspect of the invention, the first operating unit includes: a first proximal end portion that is provided rotatably with respect to a first rotation axis; and a first arm portion that extends outward from the first proximal end portion, and the second operating unit includes: a second proximal end portion that is provided rotatably with respect to a second rotation axis; and a second arm portion that extends outward from the second proximal end portion.

In the fixing structure according to one aspect of the invention, at a distal end of the first arm portion, a first restriction portion, which abuts against a side wall of a power supply unit of the electrical device and restricts a rotation range of the first arm portion to a range between a position where the power receiving unit is engaged with the power feeding unit and a position where the power receiving unit is disengaged from the power feeding unit, is provided, and at a distal end of the second arm portion, a second restriction portion, which abuts against the side wall and restricts a rotation range of the second arm portion to a range between a position where the second engagement portion is engaged with the support unit and a position where the second engagement portion is disengaged from the support unit, is provided.

In the fixing structure according to one aspect of the invention, the second rotation axis is set at a position that is substantially coaxial with a rotation axis of a main body of the electrical device.

In the fixing structure according to one aspect of the invention, the second rotation axis is set at the center of gravity of a main body of the electrical device.

In the fixing structure according to one aspect of the invention, the first arm portion has a circular arc portion A1 that is formed on a side surface thereof at the second arm portion side and that is recessed inward in the first arm portion, the first proximal end portion has a circular arc portion B1 that is formed on an outer peripheral portion thereof so as to be connected to the circular arc portion A1, the circular arc portion B1 has, in order from the circular arc portion A1 side toward a side separated from the first arm portion, a circular arc portion B11 that bulges outward, and a circular arc portion B12 that is continuous to the circular arc portion B11 and that is recessed inward, and the second arm portion has a circular arc portion A2 that is formed on a side surface thereof at the first arm portion side and that is recessed inward in the second arm portion, the second proximal end portion has a circular arc portion B2 that is formed on an outer peripheral portion thereof so as to be connected to the circular arc portion A2, the circular arc portion B2 has, in order from the circular arc portion A2 side toward a side separated from the second arm portion, a circular arc portion B21 that bulges outward, and a circular arc portion B22 that is continuous to the circular arc portion B21 and that is recessed inward, the first lock portion is formed of the circular arc portion A1 and the circular arc portion B11 of the first operating unit, and the second lock portion is formed of the circular arc portion A2 and the circular arc portion B21 of the second operating unit.

In the fixing structure according to one aspect of the invention, the circular arc portion A1, the circular arc portion B11, the circular arc portion B12, the circular arc portion A2, the circular arc portion B21, and the circular arc portion B22 all have substantially equal radii of curvature.

In the fixing structure according to one aspect of the invention, the first operating unit has a first engagement portion that is supported by the support unit of the wiring duct, and engagement and disengagement of the first engagement portion with and from the support unit is carried out simultaneously with engagement and disengagement of the power receiving unit.

An illumination device according to one aspect of the invention, includes a power supply unit and an illumination unit, wherein a fixing structure including any one of the above configurations is provided in the power supply unit.

A fixing and removing method according to one aspect of the invention is a fixing and removing method of fixing and removing an electrical device to and from a wiring duct, wherein the electrical device includes: a first operating unit that engages and disengages a power receiving unit of the electrical device with and from a power feeding unit of the wiring duct; and a second operating unit that engages and disengages a second engagement portion of the electrical device with and from a support unit of the wiring duct, and the fixing and removing method includes: when the electrical device is removed from the wiring duct, performing disengagement of the power receiving unit from the power feeding unit of the wiring duct by operating the first operating unit, so as to cancel a state, in which operation of the second operating unit is prevented; and performing disengagement of the second engagement portion from the support unit of the wiring duct by operating the second operating unit, the disengagement being performed after the disengagement of the power receiving unit; and when the electrical device is fixed to the wiring duct, performing engagement of the second engagement portion with the support unit of the wiring duct by operating the second operating unit, so as to cancel a state, in which operation of the first operating unit is prevented; and performing engagement of the power receiving unit with the power feeding unit of the wiring duct by operating the first operating unit, the engagement being performed after the engagement of the second engagement portion.

Hereinafter, a mode for carrying out the present invention (hereinafter, referred to as “embodiment”) will be described in detail, based on the appended drawings.

Throughout the whole description of the embodiment, the same elements will be appended with the same numbers.

Hereinafter, in the embodiment according to the present invention, a case, in which an electrical device is an illumination device, will be described as an example.

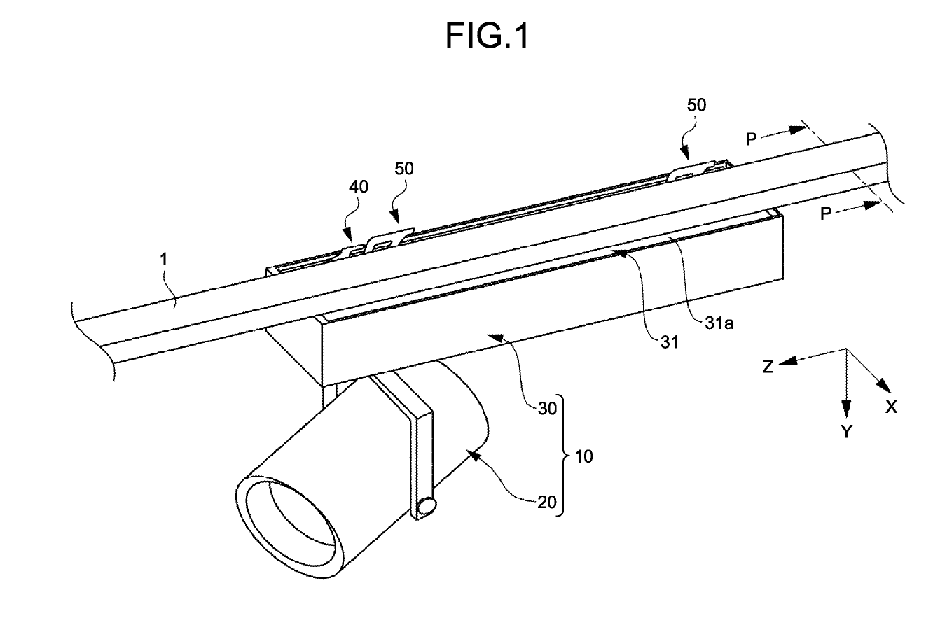

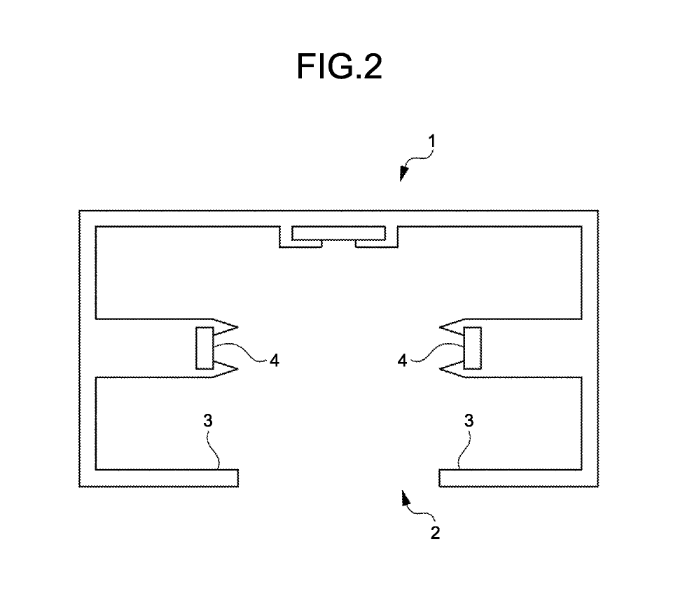

FIG. 1 is a diagram illustrating a state, in which the illumination device of the embodiment according to the present invention has been fixed to a wiring duct 1 arranged on a ceiling, a wall surface, or the like, and FIG. 2 is a sectional view of the wiring duct along a line P-P in FIG. 1.

The wiring duct 1 itself is, for example, a wiring duct as defined by JIS C8366 (lighting duct) or the like, and includes, as illustrated in FIG. 2: an opening 2 that is open in a longitudinal direction in a slit shape; a support rail serving as a support unit 3 that supports an illumination device 10 (see FIG. 1) provided along and separately from the opening 2; and a power feeding rail serving as a power feeding unit 4 that feeds power to the illumination device 10 (see FIG. 1).

As illustrated in FIG. 1, the illumination device 10 includes: an illumination unit 20 that is a main body of the illumination device 10; and a power supply unit 30.

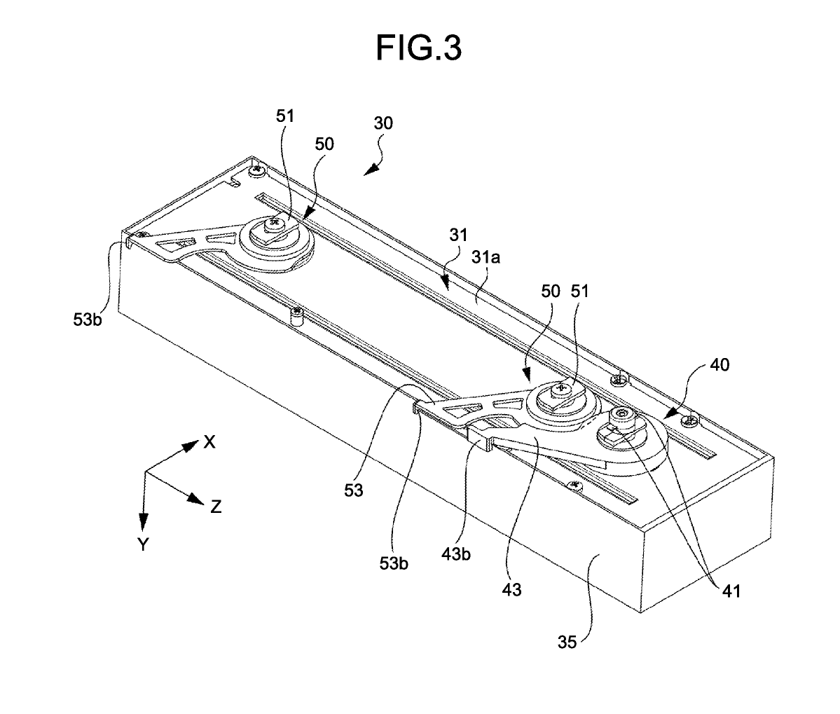

FIG. 3 is a perspective view illustrating only the power supply unit 30 of the illumination device 10 so that a wall surface portion 31 at the wiring duct 1 side in FIG. 1 is visible.

This surface of the wall surface portion 31, the surface being at the wiring duct 1 side, will be called a topside 31a, and a surface, which is positioned opposite to this topside 31a and is an inner surface of the power supply unit 30, will be called an underside 31b.

As illustrated in FIG. 3, a first operating unit 40 is provided on the wall surface portion 31, the first operating unit 40 being for engaging and disengaging power receiving portions 41, which receive power feeding from the power feeding unit 4 of the wiring duct 1, with and from the power feeding unit 4.

Further, a second operating unit 50, which is for engaging and disengaging a second engagement portion 51 supported by the support unit 3 of the wiring duct 1, with and from the support unit 3, is provided.

In this embodiment, a case, in which two of the second operating units 50 are arranged separately from each other along a longitudinal direction of the wiring duct 1, is illustrated, but not being limited to the case where the plural second operating units 50 are provided, at least one second operating unit 50 provided closely to the first operating unit 40 is preferably included.

However, by the plural second operating units 50 being provided, stable fixing to the wiring duct 1 is enabled.

Next, a detailed configuration of the first operating unit 40 and the second operating unit 50 will be described.

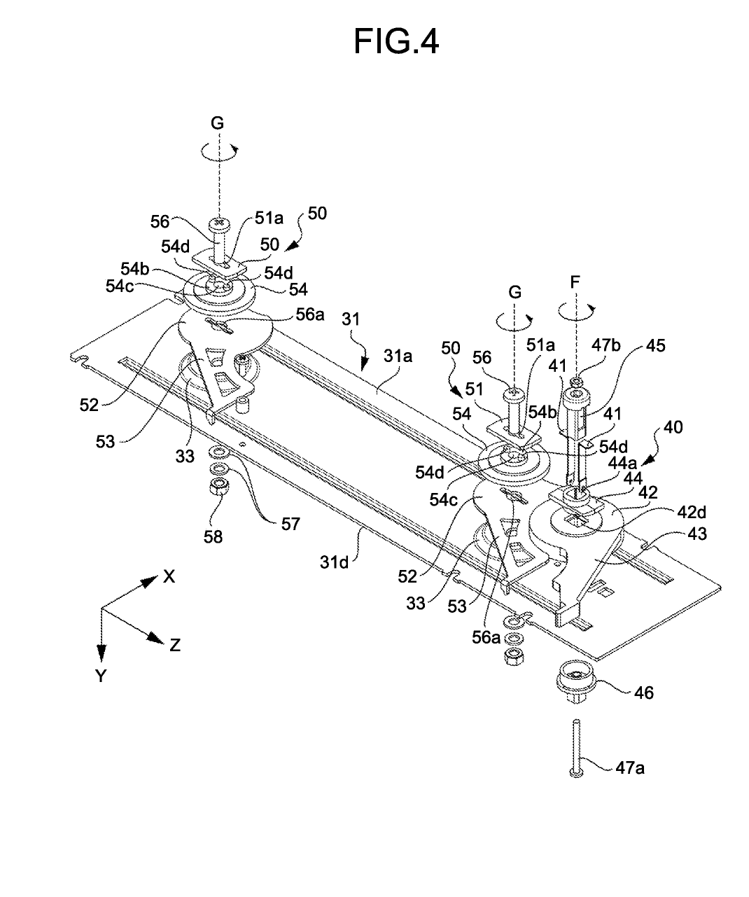

FIG. 4 is a diagram illustrating an exploded perspective view of the first operating unit 40 and second operating unit 50 illustrated in FIG. 3.

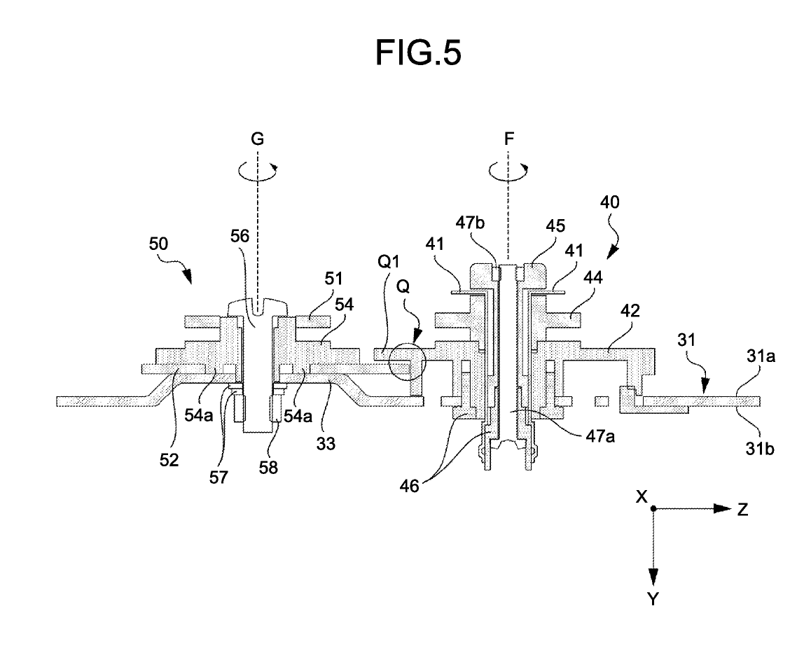

Further, FIG. 5 is a partial sectional view illustrating a state, in which the first operating unit 40 and second operating unit 50 illustrated in FIG. 4 have been attached to the wall surface portion 31 of the power supply unit 30.

First Operating Unit

As illustrated in FIG. 4, the first operating unit 40 includes: a first proximal end portion 42 that is provided rotatably with respect to a first rotation axis F; and a first arm portion 43 that extends outward from the first proximal end portion 42; and the first operating unit 40 includes a first engagement portion 44 and the power receiving portions 41, which are assembled with the first proximal end portion 42.

Since the first engagement portion 44 comes into contact with the power receiving portions 41, the first engagement portion 44 is formed of insulating resin.

Further, the first proximal end portion 42 and the first arm portion 43 are similarly formed of insulating resin.

More specifically, the first engagement portion 44 and the power receiving portions 41 are assembled with the first proximal end portion 42, such that: the power receiving portions 41, each of which has an L-shaped plate form, are arranged, with respect to an opening 42d, which is at a center of the first proximal end portion 42 and is rectangular, and to an opening 44a, which is at a center of the first engagement portion 44 and is rectangular, the openings 42d and 44a being illustrated in FIG. 4, so as to abut against respective sides of these openings 42d and 44a, the respective sides being opposite to each other in a Z-direction in the figure; and a shaft portion 45, which is rectangular, is arranged so as to be passed between the power receiving portions 41.

As described above, by the first engagement portion 44 and the power receiving portions 41 being assembled with the first proximal end portion 42, when the first arm portion 43 is operated to rotate and the first proximal end portion 42 is rotated with respect to the first rotation axis F, the first engagement portion 44 and the power receiving portions 41 are also rotated with respect to the first rotation axis F.

As illustrated in FIG. 4, a retaining member 46 is provided on the underside 31b side of the wall surface portion 31; and as illustrated in FIG. 5, the retaining member 46 is fitted to a distal end of the shaft portion 45, and the shaft portion 45 and the retaining member 46 are integrated with each other by tightening by use of a screw 47a, which is provided to penetrate through a center thereof, and a nut 47b, which is provided at a proximal end side of the shaft portion 45.

Second Operating Unit

As illustrated in FIG. 4, the second operating unit 50 includes: a second proximal end portion 52 that is provided rotatably with respect to a second rotation axis G; and a second arm portion 53 that extends outward from the second proximal end portion 52; and the second operating unit 50 includes a spacer 54 and a second engagement portion 51, which are assembled with the second proximal end portion 52.

Since the second operating unit 50 is not a portion that electrically connects to the power feeding unit 4 of the wiring duct 1, the second operating unit 50 does not need to be electrically insulated.

Therefore, the second engagement portion 51 is formed of metal, and thus has high support strength.

Further, those made by press working of metal are used as the second proximal end portion 52 and the second arm portion 53, and thus cost of parts thereof is reduced from that in a case where they are made by resin molding.

As illustrated in FIG. 4 and FIG. 5, in a portion of the wall surface portion 31, the portion being where the second proximal end portion 52 is arranged, a pedestal portion 33 is formed so as to protrude to the topside 31a side.

As described above, since the second proximal end portion 52 is formed by press working, the second proximal end portion 52 is thinner than the first proximal end portion 42, which is made by resin molding and thick, and thus the pedestal portion 33 is formed so as to make a Y-direction height position of the second proximal end portion 52 an appropriate position at a portion (see a circle Q in FIG. 5) where the first proximal end portion 42 and the second proximal end portion 52 are arranged closely to each other.

If the wall surface portion 31 is made of metal, this pedestal portion 33 is also able to be formed inexpensively by press working.

As described above, the spacer 54 is a member that is provided to make the Y-direction height position of the second engagement portion 51 in FIG. 5 an appropriate position because the second proximal end portion 52 is thinly formed.

As illustrated in FIG. 4, at a center of the second proximal end portion 52, a screw hole 56a, through which a screw 56 is passed, is formed, and the screw hole 56a is formed in a shape, in which a portion of the screw hole 56a is elongated in the Z-direction in the figure.

As illustrated in FIG. 5, in the spacer 54, projections 54a, which are fitted into the elongated hole portion of the screw hole 56a of the second proximal end portion 52, are provided.

Therefore, when the spacer 54 is assembled with the second proximal end portion 52, the spacer 54 rotates, together with the second proximal end portion 52, with respect to the second rotation axis G.

Further, as illustrated in FIG. 4, in a second engagement portion arrangement portion 54b of the spacer 54, the second engagement portion arrangement portion 54b being where the second engagement portion 51 is arranged, a pair of projections 54d are provided in the Z-direction of the figure, with a screw hole 54c interposed at a center between the pair of projections 54d.

A screw hole 51a provided at a center in the second engagement portion 51 is formed, similarly to the screw hole 56a of the second proximal end portion 52, in a shape, in which a portion of the screw hole 51a is elongated in the Z-direction in the figure.

The second engagement portion 51 is arranged on the second engagement portion arrangement portion 54b of the spacer 54, such that the elongated hole portion of the screw hole 51a is fitted with these projections 54d.

Therefore, the second engagement portion 51 also rotates, together with the second proximal end portion 52, with respect to the second rotation axis G.

Attachment to the wall surface portion 31 is carried out by: the screw 56 being passed from the topside 31a side through the respective screw holes 51a, 54c, and 56a of the second engagement portion 51, spacer 54, and second proximal end portion 52, which are illustrated in FIG. 4; and a washer 57 being inserted at a distal end of the screw 56 that has come out to the underside 31b side of the wall surface portion 31 and tightening being carried out with a nut 58, as illustrated in FIG. 5.

Method of Fixing and Removing Illumination Device

Next, a fixing and removing method of fixing and removing, to and from the wiring duct 1, the illumination device 10 including a fixing structure for the wiring duct 1, the fixing structure having the above described configuration formed of the first operating unit 40 and the second operating unit 50, will be described.

A configuration itself of the second operating unit 50 that is provided separately from the first operating unit 40 is the same as that of the second operating unit 50 that is arranged closely to the first operating unit 40, and basic operations of these second operating units 50 are similar to each other, and thus, operations and the like of the first operating unit 40 and the second operating unit 50 that is arranged closely to the first operating unit 40 will be described mainly, and description of the operation of the second operating unit 50 that is provided separately from the first operating unit 40 will be omitted.

However, as will be described in detail below, the second operating unit 50 that is arranged closely to the first operating unit 40 is operated in mutual relation to the first operating unit 40, and the second operating unit 50 that is provided separately from the first operating unit 40 is different therefrom in that it is able to be operated regardless of the operation of the first operating unit 40.

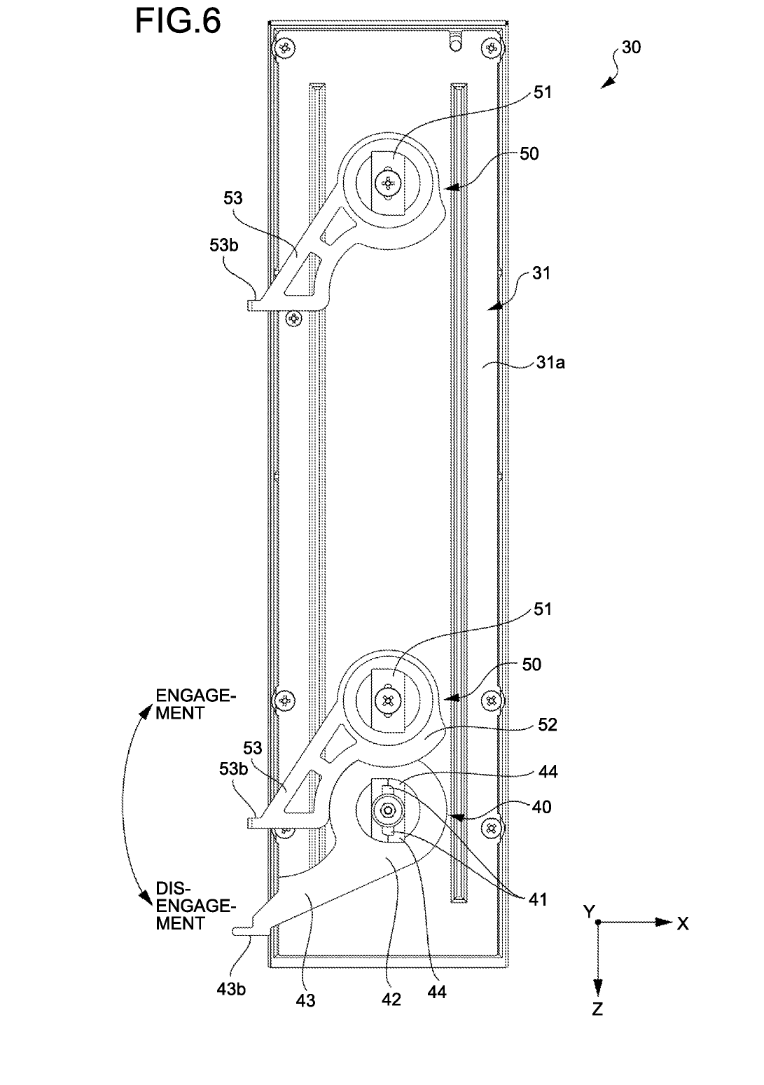

FIG. 6 to FIG. 8 are front views, in which the topside 31a of the wall surface portion 31 of the power supply unit 30 is viewed at the front.

In FIG. 6 to FIG. 8, a portion where the first proximal end portion 42 and the second proximal end portion 52 are arranged closely to each other is made visible in a front view, in which the topside 31a is viewed at the front; by a portion (see Q1 in FIG. 5) of the first proximal end portion 42 being cut off, the portion being provided so as to hide the portion of the second proximal end portion 52, this portion being at the circle Q illustrated in FIG. 5.

Further, FIG. 6 to FIG. 8 illustrate, with a two-way arrow, what kind of operation for rotation of the first arm portion 43 and the second arm portion 53 leads to the first engagement portion 44 and the second engagement portion 51 being brought into their engaged states, and are conversely brought into their disengaged states, with respect to the wiring duct 1.

Fixing to Wiring Duct

FIG. 6 illustrates a state, in which both the first arm portion 43 and the second arm portion 53 are positioned at a disengagement side, that is, before the illumination device 10 is fixed to the wiring duct 1.

Firstly, a method of fixing the illumination device 10 to the wiring duct 1 from this state (fixing step) will be described.

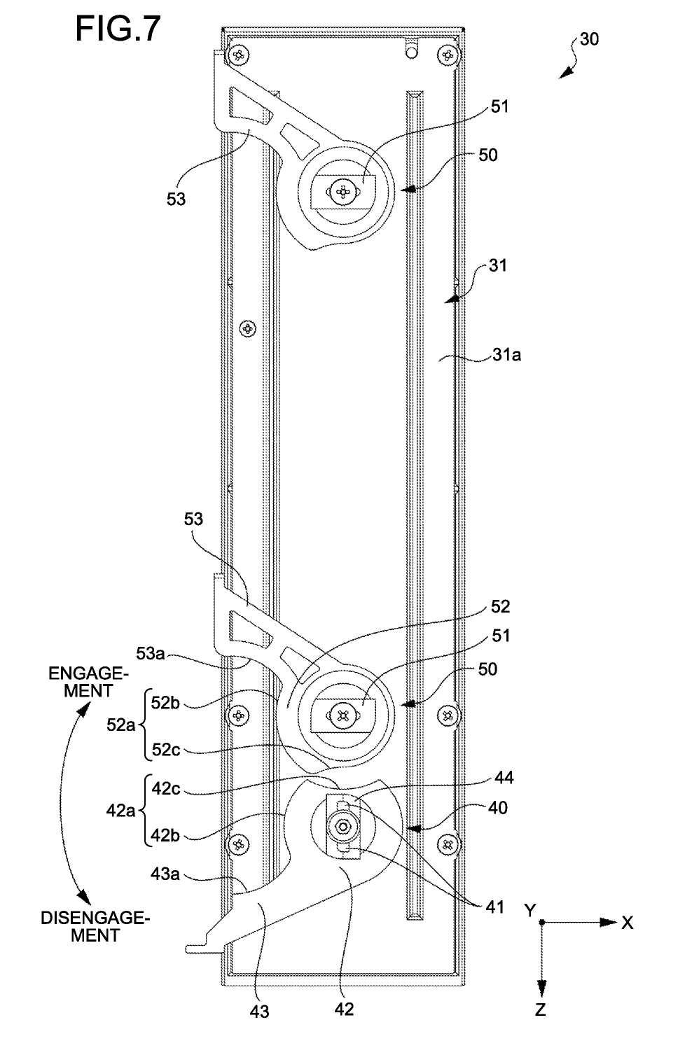

As will be understood from FIG. 6, in this state, since the first operating unit 40 is locked by the second operating unit 50 until the second operating unit 50 is operated and the second engagement portion 51 is, as illustrated in FIG. 7, brought into a state of being engaged with the support unit 3 of the wiring duct 1; the first operating unit 40 is prevented from being operated to enable an operation, in which the power receiving portions 41 are engaged with the power feeding unit 4 of the wiring duct 1.

Therefore, for fixing of the illumination device 10 to the wiring duct 1, firstly, a step C, in which the second operating unit 50 is operated and the second engagement portion 51 is engaged with the support unit 3 of the wiring duct 1, needs to be carried out, such that a state, in which the operation of the first operating unit 40 is prevented, is canceled.

Accordingly, the power receiving portions 41 are prevented from being damaged due to their inability to sustain the weight of the illumination device 10 before the second engagement portion 51 is engaged with the support unit 3 by engagement of the power receiving portions 41 with the power feeding unit 4 being carried out before the second engagement portion 51 is engaged with the support unit 3.

A specific part of the configuration of this embodiment enabling this movement will be described by reference to FIG. 7.

The second arm portion 53 has a circular arc portion 53a formed therein, the circular arc portion 53a being formed on a side surface thereof at a rotation direction side for disengagement of the second engagement portion 51 and being recessed inward in the second arm portion 53; and the second proximal end portion 52 has a circular arc portion 52a provided therein, the circular arc portion 52a being formed on an outer peripheral portion thereof so as to be connected to the circular arc portion 53a.

Further, this circular arc portion 52a provided in the second proximal end portion 52 is formed of, in order from the circular arc portion 53a side toward the rotation direction for disengagement of the second engagement portion 51: a circular arc portion 52b that bulges outward; and a circular arc portion 52c that is continuous to the circular arc portion 52b and recessed inward.

By this provision of the circular arc portions in the second operating unit 50, the circular arc portion 53a and the circular arc portion 52b serve as a second lock portion that locks the first proximal end portion 42 of the first operating unit 40, and prevent the operation of the first operating unit 40 as illustrated in FIG. 6.

As illustrated in FIG. 7, when the second operating unit 50 has been operated to the engagement side, the circular arc portion 52c of the second operating unit 50 serves as a second receiving portion that receives the first proximal end portion 42 of the first operating unit 40, and operation for rotation of the first operating unit 40 to the engagement side is enabled.

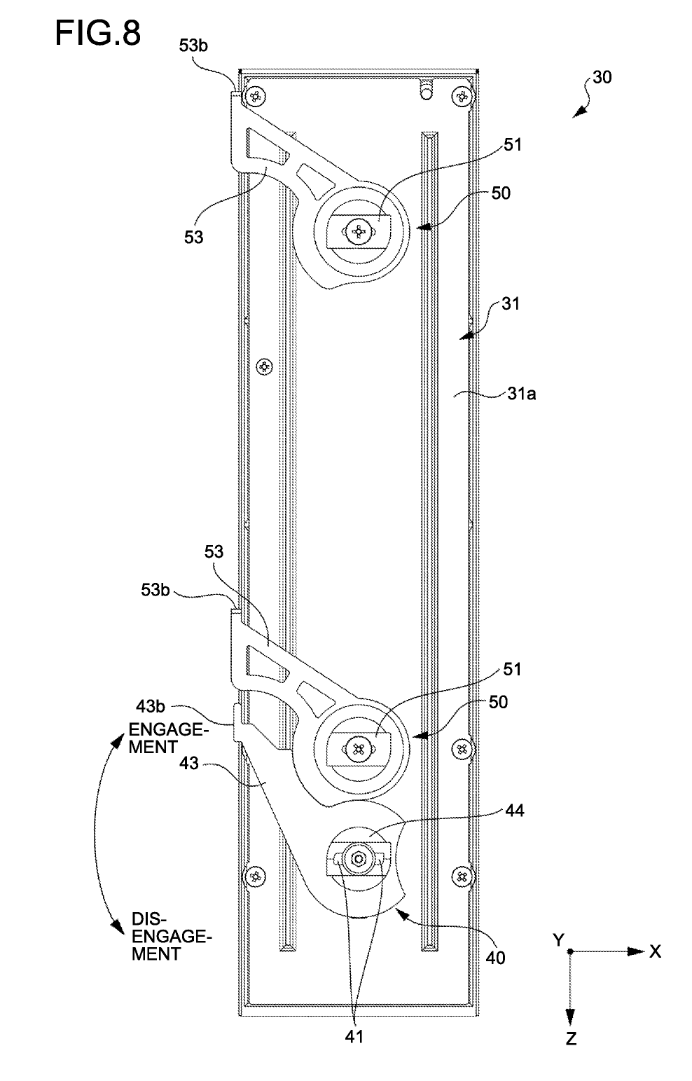

Since the operation of the first operating unit 40 is enabled after the step C has been performed as illustrated in FIG. 7, subsequently, a step D, in which the first operating unit 40 is operated and the power receiving portions 41 are engaged with the power feeding unit 4 of the wiring duct 1, is carried out, and as illustrated in FIG. 8, a state, in which the first operating unit 40 and the second operating unit 50 have both been operated to the engagement side, that is, a state, in which the illumination device 10 has been fixed to the wiring duct 1, is reached.

Removal from Wiring Duct

As described above, FIG. 8 is in the state where the illumination device 10 has been fixed to the wiring duct 1.

Next, a method of removing the illumination device 10 from this state (removing step) will be described.

As will be understood from FIG. 8, in this state, since the second operating unit 50 is locked by the first operating unit 40 until the first operating unit 40 is operated and a state, in which the power receiving portions 41 are disengaged from the power feeding unit 4 of the wiring duct 1, as illustrated in FIG. 7, is reached; the second operating unit 50 is prevented from being operated to enable an operation, in which the second engagement portion 51 is disengaged from the support unit 3 of the wiring duct 1.

Therefore, for removal of the illumination device 10 from the wiring duct 1, firstly, a step A, in which the first operating unit 40 is operated and the power receiving portions 41 are disengaged from the power feeding unit 4 of the wiring duct 1, needs to be carried out, such that a state, in which the operation of the second operating unit 50 is prevented, is canceled.

Accordingly, the power receiving portions 41 are prevented from being damaged due to their inability to sustain the weight of the illumination device 10 before disengagement of the power receiving portions 41 from the power feeding unit 4 is carried out by disengagement of the second engagement portion 51 being carried out before the disengagement of the power receiving portions 41 from the power feeding unit 4 is carried out.

A specific part of the configuration of this embodiment enabling this movement will be described by reference to FIG. 7.

The first arm portion 43 has a circular arc portion 43a formed therein, the circular arc portion 43a being formed on a side surface thereof at a rotation direction side for engagement of the power receiving portions 41 and being recessed inward in the first arm portion 43; and the first proximal end portion 42 has a circular arc portion 42a provided therein, the circular arc portion 42a being formed on an outer peripheral portion thereof so as to be connected to the circular arc portion 43a.

Further, this circular arc portion 42a provided in the first proximal end portion 42 is formed of, in order from the circular arc portion 43a side toward the rotation direction for engagement of the power receiving portions 41: a circular arc portion 42b that bulges outward; and a circular arc portion 42c that is continuous to the circular arc portion 42b and recessed inward.

By this provision of the circular arc portions in the first operating unit 40, the circular arc portion 43a and the circular arc portion 42b serve as a first lock portion that locks the second proximal end portion 52 of the second operating unit 50, and prevent the operation of the second operating unit 50 as illustrated in FIG. 8.

As illustrated in FIG. 7, when the first operating unit 40 has been operated to the disengagement side, the circular arc portion 42c of the first operating unit 40 serves as a first receiving portion that receives the second proximal end portion 52 of the second operating unit 50, and operation for rotation of the second operating unit 50 to the disengagement side is enabled.

Since the operation of the second operating unit 50 is enabled after the step A has been performed as illustrated in FIG. 7, subsequently, a step B, in which the second operating unit 50 is operated and the second engagement portion 51 is disengaged from the support unit 3 of the wiring duct 1, is carried out, and as illustrated in FIG. 6, a state, in which the first operating unit 40 and the second operating unit 50 have both been operated to the disengagement side, that is, a state, in which the illumination device 10 has been removed from the wiring duct 1, is reached.

The circular arc portions 43a, 42b, 42c, 53a, 52b, and 52c of this embodiment are circular arc portions formed of circular arcs having substantially equal radii of curvature.

Further, a positional relation between the first operating unit 40 and the second operating unit 50 is arranged such that the circular arc portion 42c of the first operating unit 40 and the circular arc portion 52b of the second operating unit 50 that have been described by reference to FIG. 7 are able to be linked to each other via a small gap allowing sliding rotation as illustrated in FIG. 6.

As illustrated in FIG. 3, at a distal end of the first arm portion 43, a first restriction portion 43b, which is made to be abuttable against a side surface 35 of the power supply unit 30 by being protruded to the side surface 35 side from the distal end of the first arm portion 43, and which restricts a rotation range of the first arm portion 43, is provided.

Specifically, as will be understood from FIG. 6 and FIG. 8, this first restriction portion 43b restricts the rotation range of the first arm portion 43 to a range between a position, at which the power receiving portions 41 are engaged with the power feeding unit 4, and a position, at which the power receiving portions 41 are disengaged from the power feeding unit 4.

Further, as illustrated in FIG. 3, at a distal end of the second arm portion 53, a second restriction portion 53b, which is made to be abuttable against the side surface 35 of the power supply unit 30 by being protruded to the side surface 35 side from the distal end of the second arm portion 53, and which restricts a rotation range of the second arm portion 53, is provided.

Specifically, as will be understood from FIG. 6 and FIG. 8, this second restriction portion 53b restricts the rotation range of the second arm portion 53 to a range between a position, at which the second engagement portion 51 is engaged with the support unit 3, and a position, at which the second engagement portion 51 is disengaged from the support unit 3.

Therefore, the operation for rotation of the first arm portion 43 just needs to be performed until the operation is restricted by the first restriction portion 43b, and the first arm portion 43 is prevented from being excessively rotated; and similarly, the operation for rotation of the second arm portion 53 just needs to be performed until the operation is restricted by the second restriction portion 53b, and the second arm portion 53 is prevented from being excessively rotated.

In addition, in this embodiment, as will be understood from FIG. 6, one pair of corners of each of the first engagement portion 44, the power receiving portions 41, and the second engagement portion 51, the one pair of corners being positioned diagonally, are chamfered in R-shapes.

More specifically, a corner close to the first arm portion 43 and a corner diagonal thereto, of each of the first engagement portion 44 and the power receiving portions 41, are chamfered in R-shapes.

Similarly, a corner close to the second arm portion 53 and a corner diagonal thereto, of the second engagement portion 51, are also chamfered in R-shapes.

The chamfered corners are corners, which are at an insertion start side with respect to rails (support rail and power feeding rail) of the wiring duct 1 upon engagement, and which rotate along the rails, and thus, by being chamfered as described above, upon engagement and disengagement, the corners are prevented from being caught in the rails, and smooth operation is enabled.

Further, if the illumination unit 20 of the illumination device 10 is able to be rotationally driven with respect to the wiring duct 1 such that the illumination direction is able to be changed arbitrarily, from the viewpoint of stability of fixing upon the rotational drive of the illumination unit 20, the second rotation axis G of the second operating unit 50 arranged closely to the first operating unit 40 (see FIG. 4 and FIG. 5) is preferably set to be coaxial with a rotation axis of the rotational drive of the illumination unit 20.

In this embodiment, the illumination device 10 has been described as an example, but if, for example, the targeted electrical device is something like a camera device, and a camera, which is a main body of the camera device, is able to be rotationally driven, the second rotation axis G (see FIG. 4 and FIG. 5) of the second operating unit 50 arranged closely to the first operating unit 40 is preferably set to be coaxial with a rotation axis of the rotational drive of the camera, which is the main body.

Therefore, the second rotation axis G of the second operating unit 50 is preferably set to be coaxial with the rotation axis of the rotational drive of the main body (for example, the illumination unit 20 or the camera) of the electrical device, such as the illumination device 10 or the camera device.

On the contrary, if the illumination unit 20 is not rotationally driven, from the viewpoint of stable reception of the weight of the illumination unit 20, the second rotation axis G of the second operating unit 50 arranged closely to the first operating unit 40 is preferably set at the center of gravity of the illumination unit 20.

If, for example, the electrical device is a camera device, instead of the illumination device 10, the second rotation axis G of the second operating unit 50 arranged closely to the first operating unit 40 is preferably set at the center of gravity of a camera, which is a main body of the camera device.

Therefore, if the electrical device is not rotationally driven, the second rotation axis G of the second operating unit 50 arranged closely to the first operating unit 40 is preferably set at the center of gravity of the main body (for example, the illumination unit 20 or the camera) of the electrical device, such as the illumination device 10 or the camera device.

The present invention has been described above based on the embodiment, but the present invention is not limited to the embodiment, and various modifications may be made without departing from the gist of the present invention.

As will be understood from FIG. 7, in this embodiment, the first operating unit 40 and the second operating unit 50 are arranged such that the second operating unit 50 is arranged at the engagement side of the arm operation (first arm portion 43 and second arm portion 53) and the first operating unit 40 is arranged at the disengagement side thereof, but needless to say, this arrangement relation may be reversed.

In that case, shapes of the circular arc portions 53a and 52a of the second operating unit 50 described above may be applied to the first operating unit 40, and shapes of the circular arc portions 43a and 42a of the first operating unit 40 may be applied to the second operating unit 50.

Therefore, for easy contrast among FIG. 6 to FIG. 8 with the description of the operation, the shapes of the circular arc portions have been described with reference to the rotation direction, in which the power receiving portions 41 are engaged, and the rotation direction, in which the second engagement portion 51 is disengaged, but hereinafter, general representation will be described by reference to FIG. 7 again, the general representation including a case where the first operating unit 40 and the second operating unit 50 illustrated in FIG. 6 to FIG. 8 are arranged with their positional relation reversed.

The first arm portion 43 has the circular arc portion 43a (an example of a circular arc portion A1 of the present invention), which is formed on a side surface thereof at the second arm portion 53 side and is recessed inward in the first arm portion 43; and the first proximal end portion 42 has the circular arc portion 42a (an example of a circular arc portion B1 of the present invention), which is formed on the outer peripheral portion thereof so as to be connected to the circular arc portion 43a.

The circular arc portion 42a (the example of the circular arc portion B1 of the present invention) has, in order from the circular arc portion 43a side toward a side separated from the first arm portion 43: the circular arc portion 42b (an example of a circular arc portion B11 of the present invention) that bulges outward; and the circular arc portion 42c (an example of a circular arc portion B12 of the present invention) that is continuous to the circular arc portion 42b and recessed inward.

The second arm portion 53 has the circular arc portion 53a (an example of a circular arc portion A2 of the present invention), which is formed on a side surface thereof at the first arm portion 43 side and is recessed inward in the second arm portion 53; and the second proximal end portion 52 has the circular arc portion 52a (an example of a circular arc portion B2 of the present invention), which is formed on the outer peripheral portion thereof so as to be connected to the circular arc portion 53a.

The circular arc portion 52a (the example of the circular arc portion B2 of the present invention) has, in order from the circular arc portion 53a side toward a side separated from the second arm portion 53: the circular arc portion 52b (an example of a circular arc portion B21 of the present invention) that bulges outward; and the circular arc portion 52c (an example of a circular arc portion B22 of the present invention) that is continuous to the circular arc portion 52b and recessed inward.

By the circular arc portions being formed as described above, the first operating unit 40 and the second operating unit 50 enable the effects described above in “Method of Fixing and Removing Illumination Device” to be achieved, even if the first operating unit 40 is arranged at the engagement side of the arm operation (an example of the first arm portion 43 and the second arm portion 53) and the second operating unit 50 is arranged at the disengagement side thereof, or even if, on the contrary, the second operating unit 50 is arranged at the engagement side and the first operating unit 40 is arranged at the disengagement side.

Further, although the above embodiment has been specifically described mainly with the illumination device being the example, as already mentioned a little, the fixing structure according to the present invention may be applied generally to, in addition to the electrical device, such as the illumination device, an electrical device, which is fixed to a wiring duct, such as a camera device, for example.

Accordingly, the present invention is not limited to the specific embodiment, includes various modifications thereof, and such is evident to those skilled in the art from the statement of the claims.

According to an aspect of the present invention, an electrical device, such as an illumination device, for which damage thereof due to an overload on a power receiving unit thereof upon fixing and removal of the electrical device to and from a wiring duct is prevented, is able to be provided.

1. A fixing structure for fixing an electrical device to a wiring duct, the fixing structure including:
a first operating unit that has a power receiving unit, which receives power feeding from a power feeding unit of the wiring duct, and that engages and disengages the power receiving unit with and from the power feeding unit;
a second operating unit that has a second engagement portion supported by a support unit of the wiring duct, and that engages and disengages the second engagement portion with and from the support unit; and
a first lock portion that is provided in the first operating unit and that locks the second operating unit.

2. The fixing structure according to claim 1, wherein by the second operating unit being locked by the first lock portion, an operation of the second operating unit is prevented, the operation being for disengagement of the second engagement portion from the support unit, until the power receiving unit is disengaged from the power feeding unit.

3. The fixing structure according to claim 1, wherein
the second operating unit includes a second lock portion that locks the first operating unit, and
by the first operating unit being locked by the second lock portion, an operation of the first operating unit is prevented, the operation being for engagement of the power receiving unit with the power feeding unit, until the second engagement portion is engaged with the support unit.

4. The fixing structure according to claim 3, wherein
the first operating unit includes: a first proximal end portion that is provided rotatably with respect to a first rotation axis; and a first arm portion that extends outward from the first proximal end portion, and
the second operating unit includes: a second proximal end portion that is provided rotatably with respect to a second rotation axis; and a second arm portion that extends outward from the second proximal end portion.

5. The fixing structure according to claim 4, wherein
at a distal end of the first arm portion, a first restriction portion, which abuts against a side wall of a power supply unit of the electrical device and restricts a rotation range of the first arm portion to a range between a position where the power receiving unit is engaged with the power feeding unit and a position where the power receiving unit is disengaged from the power feeding unit, is provided, and
at a distal end of the second arm portion, a second restriction portion, which abuts against the side wall and restricts a rotation range of the second arm portion to a range between a position where the second engagement portion is engaged with the support unit and a position where the second engagement portion is disengaged from the support unit, is provided.

6. The fixing structure according to claim 4, wherein the second rotation axis is set at a position that is substantially coaxial with a rotation axis of a main body of the electrical device.

7. The fixing structure according to claim 4, wherein the second rotation axis is set at the center of gravity of a main body of the electrical device.

8. The fixing structure according to claim 4, wherein
the first arm portion has a circular arc portion A1 that is formed on a side surface thereof at the second arm portion side and that is recessed inward in the first arm portion,
the first proximal end portion has a circular arc portion B1 that is formed on an outer peripheral portion thereof so as to be connected to the circular arc portion A1,
the circular arc portion B1 has, in order from the circular arc portion A1 side toward a side separated from the first arm portion, a circular arc portion B11 that bulges outward, and a circular arc portion B12 that is continuous to the circular arc portion B11 and that is recessed inward, and the second arm portion has a circular arc portion A2 that is formed on a side surface thereof at the first arm portion side and that is recessed inward in the second arm portion,
the second proximal end portion has a circular arc portion B2 that is formed on an outer peripheral portion thereof so as to be connected to the circular arc portion A2,
the circular arc portion B2 has, in order from the circular arc portion A2 side toward a side separated from the second arm portion, a circular arc portion B21 that bulges outward, and a circular arc portion B22 that is continuous to the circular arc portion B21 and that is recessed inward,
the first lock portion is formed of the circular arc portion A1 and the circular arc portion B11 of the first operating unit, and
the second lock portion is formed of the circular arc portion A2 and the circular arc portion B21 of the second operating unit.

9. The fixing structure according to claim 8, wherein the circular arc portion A1, the circular arc portion B11, the circular arc portion B12, the circular arc portion A2, the circular arc portion B21, and the circular arc portion B22 all have substantially equal radii of curvature.

10. The fixing structure according to claim 1, wherein the first operating unit has a first engagement portion that is supported by the support unit of the wiring duct, and engagement and disengagement of the first engagement portion with and from the support unit is carried out simultaneously with engagement and disengagement of the power receiving unit.

11. An illumination device, comprising:
a power supply unit and an illumination unit, wherein
the fixing structure according to claim 1 is provided in the power supply unit.

12. A fixing and removing method of fixing and removing an electrical device to and from a wiring duct, wherein
the electrical device includes: a first operating unit that engages and disengages a power receiving unit of the electrical device with and from a power feeding unit of the wiring duct; and a second operating unit that engages and disengages a second engagement portion of the electrical device with and from a support unit of the wiring duct, and
the fixing and removing method includes:
when the electrical device is removed from the wiring duct,
performing disengagement of the power receiving unit from the power feeding unit of the wiring duct by operating the first operating unit, so as to cancel a state, in which operation of the second operating unit is prevented; and
performing disengagement of the second engagement portion from the support unit of the wiring duct by operating the second operating unit, the disengagement being performed after the disengagement of the power receiving unit; and
when the electrical device is fixed to the wiring duct,
performing engagement of the second engagement portion with the support unit of the wiring duct by operating the second operating unit, so as to cancel a state, in which operation of the first operating unit is prevented; and
performing engagement of the power receiving unit with the power feeding unit of the wiring duct by operating the first operating unit, the engagement being performed after the engagement of the second engagement portion.
